(19) United States
(12) Patent Application Publication
(10) Pub. No.: US 2011/0251514 A1
(43) Pub. Date: Oct. 13, 2011

(54) LIVESTOCK TEMPERATURE MONITORING AND DETECTION SYSTEM

(76) Inventors: ALVIN FULTS, Amarillo, TX (US); Tim Moreland, Amarillo, TX (US); Richard Crider, JR., Amarillo, TX (US)

(21) Appl. No.: 12/756,993

(22) Filed: Apr. 8, 2010

(51) Int. Cl. A61B 5/01

(52) U.S. Cl. 600/549

(57) ABSTRACT

Disclosed herein is a livestock temperature measuring and detection system. The system includes a housing, typically made from engineering plastic. Within the housing is a probe defining a thermistor having a threshold temperature. The thermistor is inserted in the livestock's ear. The threshold temperature is pre-set for monitoring a particular livestock condition. The housing includes a visible display. The housing includes a microprocessor which monitors the thermistor and upon detecting the threshold signal activates the display for visible observation.

### FIELD OF THE INVENTION

This invention generally relates to the field of diagnostic tools for livestock. More particularly, this invention relates to a system having data tags applied to livestock, more particularly their ears and a means for retrieving data from the tags so placed.

### BACKGROUND OF THE INVENTION

In the field of cattle management, particularly, breeding, it is critical to know the precise time when a cow is in estrus, Consistently knowing when a cow or other stock is in estrus increases the ability of the manager to have high yields of pregnant cows.

In the past, hormones have been used extensively to assist the manager in obtaining high yields. Hormonal stimulations, while effective, can be costly and time consuming. For large herds, the costs can sky rocket when both the costs of the hormones and the costs of labor are properly calculated. Increasing production schedules on the cows and the use of hormonal stimulations make consistent impregnation increasingly more difficult.

It has been an observed scientific and medical fact that temperature and a cow's estrus cycle are related. Once a cow's normal or nominal temperature is ascertained, a drop in temperature of 0.6° F. can very well indicate that estrus is about to begin. This temperature drop is known as a “quick spike.”

Additionally, it has also been observed that cows and other livestock health correspond to their core temperature. When a cow or other livestock runs a fever, it can signal that the animal has an infection or some illness, disease or is in some way distressed. For example when a cow reaches the temperature of 103.6° F., this is indicative of the cow having a fever. While, it is clear that not all such animals need to be treated with anti-biotics, at the very least, it signals that the manager needs to pay closer attention to a feverish cow or other similar livestock. Thus, knowing when a cow or other livestock first has a fever is advantageous and allows for early treatment

Clearly, if a manager knows that his livestock needs treatment at an early stage the prognosis for such an animal is far better than when symptoms appear that cannot be reversed. Catching a disease or illness at an early stage cut the mortality rate significantly.

Additionally, catching a disease or illness or even discomfort at the early stages can make the difference between a long hard struggle to survive compared with a simple matter of treating the animals with low dosage medicine. Or, even no medicine. For example, in hot, dry summer days in many parts of the world, including the United States, cows and other livestock will dehydrate quite rapidly. Some animals are much more susceptible to such circumstances than others. Mere guesswork to identify those animals needing special hydration needs leads to many unhappy cows and then consequently unhappy managers.

A more scientific method of determining when a cow or other livestock is in distress is needed. As will be described below, this application is devoted to assisting the manager find such methods with minimum intrusion to the livestock.

At least one individual recognized that especially for large herds, it would be useful to do temperature monitoring of the cows. Hixson, U.S. Pat. No. 7,196,628, discloses a solar powered device, which features a keyboard and a solar array for powering the device. The device requires the use of a keypad, a display panel and a solar cell panel. Each time the device is used it must be reset using the keypad.

In order to take advantage of natural events related to temperature, Applicant's believe what is needed is a simple and effective system, which allows the manager positive indication of possible conditions that livestock may be in distress at an early stage. The system should include a method for applying a device to the ear of a cow or similar livestock without affecting the estrus cycle. The system should be non-invasive so that the animal will be subject to a minimum amount of stress, non-intrusive to the estrus cycle, during application of such a device. And, further, what is needed is such a system that allows for early diagnosis of possible distress without the need for complex electronic equipment or specially powered ear tags. The ideal system allows for a manager to easily visually inspect a herd, even a large herd, without the need for complex external monitoring devices.

### SUMMARY OF THE INVENTION

The device, in accordance with the present invention, is a temperature detection device for measuring and monitoring the core temperature of selected livestock. In an exemplary for testing fever in beef cattle, the device is pre-set with a threshold temperature to monitor temperature. The threshold temperature is this example is set at 108.6° F. The device is typically pre-set with the above threshold temperature by the manufacturer.

The device in accordance with the invention uses a thermistor to measure temperature. The device in accordance with the invention includes a microprocessor, which monitors the temperature of the thermistor. Upon reaching the threshold temperature, the microprocessor is programmed to send a signal to a display. In an exemplary embodiment the display is visible even in bright daylight. The signal from the microprocessor activates the display once the threshold temperature is reached.

In use the thermistor is inserted into the cow or other livestock's ear to measure, accurately, core temperature. The device is applied to the ear of the animal in ways traditional to the industry and does not harm or cause the animal to go into distress upon attachment.

Thus, it is an object of this invention is to provide a safe and highly accurate method of monitoring the temperature of livestock.

It is another object of the device in accordance with this invention, to provide a structure, which requires little or no manual upkeep and is simple to use and requires no external computer or other complex equipment.

It is an additional object of this invention to provide a safe and simple to use device, which follows the general standards of high quality animal husbandry.

In exemplary embodiment of the temperature monitoring and detection device in accordance with the invention, comprises:
a housing;
the housing including a probe;
   the probe having a pre-set threshold temperature, the probe including:
   a temperature sensing means for detecting an animal's temperature;
   a display means, the display means visibly indicating when the pre-set threshold temperature has been reached; and
   a monitoring means for monitoring when the threshold temperature is detected, the monitoring means including means for sending a signal to the display means for activating the display means when the threshold temperature has been reached.

In an exemplary embodiment, the temperature sensing means defines a thermistor. The thermistor is typically a long probe, which, in the exemplary embodiment, fits down the ear canal of the livestock, and measures core temperature. This provides the manager with a highly accurate means for detecting the livestock's core temperature. Additionally, it is much more accurate than other automated methods of measuring core temperature that are currently available.

In another exemplary embodiment, the display defines ultra-bright LEDs are used. These LEDs are easily visible, even in bright sunshine, typical of where cows are raised.

In another exemplary embodiment, the housing is made from engineering plastic and more particularly UV polycarbonate. The housing is thusly, highly reliable and rugged and able to withstand environmental conditions as well as rigors of being attached to the animal. Additionally, UV polycarbonate provides sufficient insulation to resist degradation in the sun and ambient temperatures, which are typical conditions for cows and other livestock.

In another exemplary embodiment, the microprocessor includes the ability for retaining 12 hours of data. The microprocessor includes an algorithm, which compares each of the previous reading. In this embodiment, the microprocessor is looking for a “quick spike” as the threshold condition. Should there be a “quick spike”, the microprocessor sends the signal to the display means activating the display for visual recognition of the possible onset of estrus.

It is an advantage of the device in accordance with this invention to provide a safe, reliable system for monitoring the temperature of livestock.

It is an additional advantage of the system in accordance with this invention to provide a means for readily identifying which livestock need additional attention for the condition or conditions being monitored.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a partially exposed perspective view of the device in accordance with the detecting livestock detecting temperature system of the invention.

FIG. 2 is a perspective view of the structure for attaching the device in accordance with this invention to the ear of livestock, particularly shown is a cow.

FIG. 3 illustrates the method of applying the device in accordance with this invention to livestock, and more particularly, a cow.

FIG. 4 illustrates the device and more particularly the structure for displaying the threshold condition of temperature for the livestock.

### DETAILED DESCRIPTION OF THE INVENTION

In order to appreciate the invention herein, one must appreciate the need in the art as set forth in the Background. Most importantly, the structure herein for resolving the long felt need to readily identify the livestock, and particularly cattle, who may be in distress or exhibit their estrus cycle without the need for complex electronics, special portable power or computers. For many ranchers, the cost of such external device can be the difference between making a profit and losing the ranch.

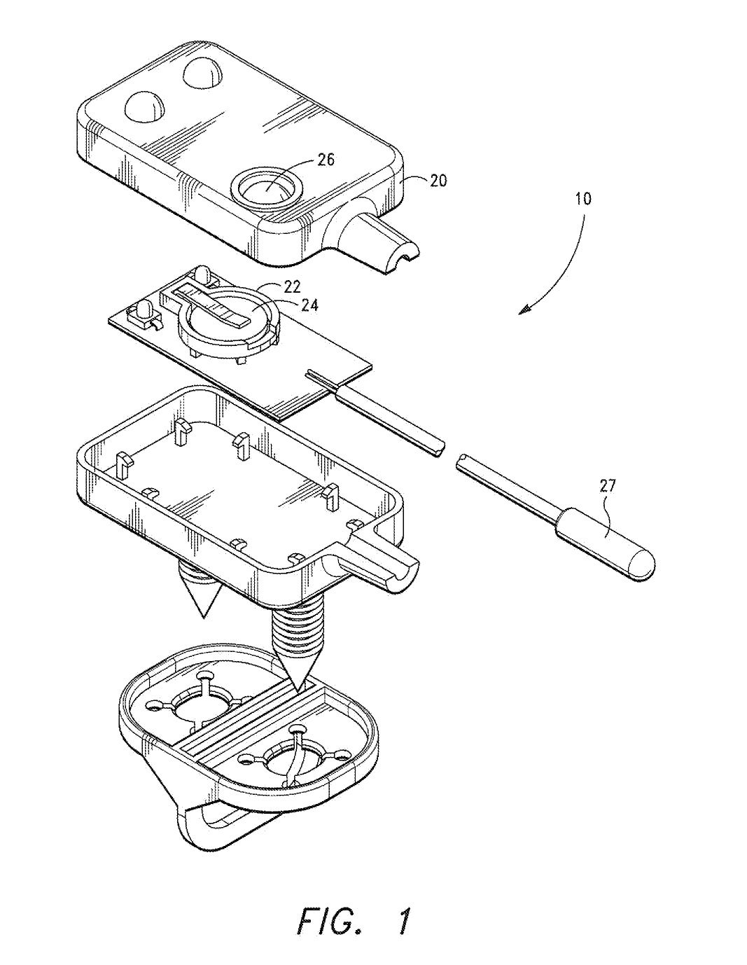

An exemplary embodiment of the detection system in accordance with this invention is illustrated in FIG. 1 and the system is generally designated by the numeral 10. The system 10 includes a housing 20. The housing 20 includes a probe 22, a microprocessor 24 and visible LEDs 26.

The probe 22 includes an ultra-sensitive thermistor 27. The thermistor 27 of the probe 22 defines a temperature sensor. Like all thermistors, the thermistor of the probe 22 is highly accurate within a limited range. Of course, within the spirit and scope of the invention, only a limited range for triggering the threshold condition to be tested is needed. Thus, for purposes of the invention, the thermistor accomplishes the functions necessary in a satisfactory and completely functional manner within the spirit and scope of the invention.

The thermistor 27 includes temperature-sensing means for sensing the animal's core temperature. The sensing means acts like a digital thermometer. The sensing means has a threshold temperature. Upon reaching the threshold condition, in the case of monitoring for fever in beef cattle, the threshold temperature of 103.6° F., a signal is sent from the microprocessor 24 activating the display means.

The microprocessor 24 is connected to the probe and monitors receive data from the thermistor 27. As noted above the microprocessor may be set for various threshold conditions. Upon detecting a threshold condition, the microprocessor 24 sends a signal to the LEDs 26 to become active.

In the case where the threshold condition to be detected is fever for beef cattle, the threshold condition is set as a temperature of 103.6° F. Upon the microprocessor recording the threshold condition of 103.6° F., a signal is sent activating the display.

In the case where, the condition to be monitored is estrus, the microprocessor 24 includes the ability for retaining 12 hours of data from the thermistor 27. The microprocessor 24 includes an algorithm, which compares each of the previous readings. In this embodiment, the threshold condition is the “quick spike”. Upon successive comparisons of the thermistor 27 data, the microprocessor is able to detect, where it occurs, the threshold condition. Should there be a “quick spike”, the microprocessor sends the signal to the display activating the LEDs 26 for visual recognition of the possible onset of estrus.

The LEDs 26 are attached to the housing 20 and electrically connected to the microprocessor 24. Upon receiving the threshold signal, enough voltage is sent across the electrical connection between the microprocessor 24 and the LEDs 26 to activate or light the LEDs 26.

The LEDs 27 define a group of ultra-bright LEDs. Such LEDs are made especially for the device in accordance with the invention by Ledtronics and Brightek. These special LEDs 27 can be seen in daylight, and even in bright daylight.

Each of the above components is powered by a replaceable power source 28 (FIG. 4). For example, in one exemplary embodiment, the power source is a coin cell lithium battery. The battery is a 560-mAh-coin cell.

The housing 20 stores all the above components in a plastic housing. The housing is in an exemplary embodiment made from engineering plastic and in particular, UV Polycarbonate. The polycarbonate insulates the components from virtually all ambient temperatures.

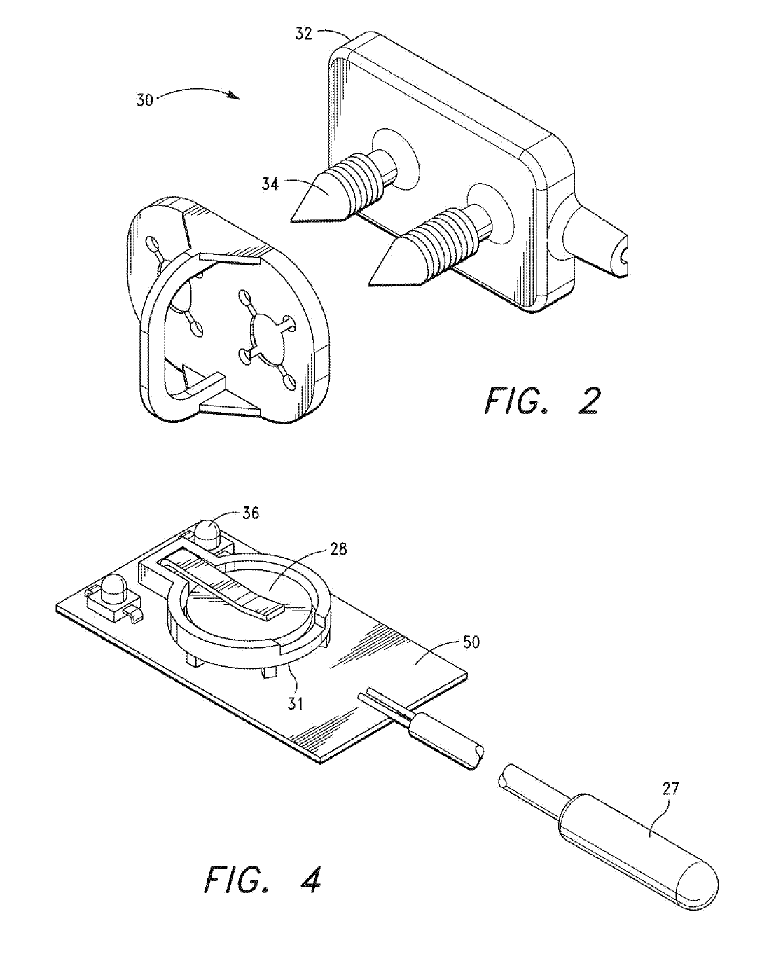

With particular reference to FIG. 2, there is shown the attachment structure, generally shown by the numeral 30 provides means for connecting the housing 20 to the animal's ear. The housing 20 includes the attachment structure. The attachment structure includes two members 31 and 32. Member 31 forms the base plate of the housing 20 while member 32 defines the backing plate of the attachment structure 30.

As seen in FIG. 2, each of the plate 31 includes insertable prongs 34. Likewise, the backing plate has compatible openings 36. When the insertable prongs 34 are aligned with the openings 36, pressure from the pliers 40 forces the prongs into their compatible openings. This forms at least a semi-permanent attachment, which cannot be removed by the livestock.

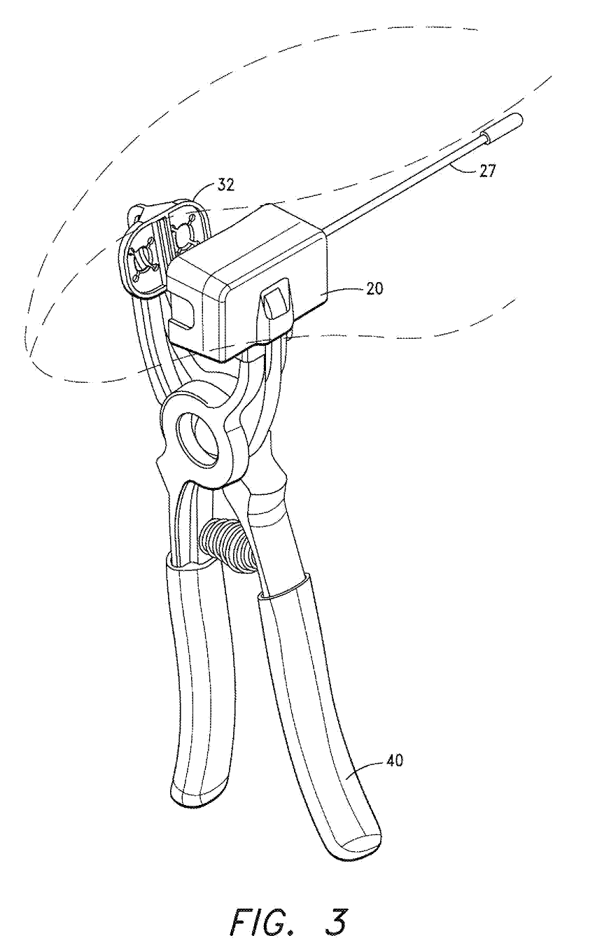

The backing plate 32 additionally includes a handle 37. Handle 37 forms an outwardly projecting structure. Handle 37 is useful in aligning the plates 31 and 32, namely the prongs 34 with the openings 36. Additionally, the handle 37 provides a gripping point for the pliers 40 as seen clearly in FIG. 3.

In use, the livestock's head, e.g. a cow's head, into a head shute, thereby immobilizing the livestock's head. Using the pliers 40 of FIG. 3 to steady the housing 20, the thermistor 27 in inserted into the livestock's ear and the plates 31 and 32 are aligned as described above. Once the thermistor 27 is inserted and the plates 31 and 32 are aligned, the pliers 40 are used to press the plates 31 and 32 together.

With particular reference to FIG. 4, there is shown a cross sectional view of the housing 20. The battery 28 fits centrally and is electrically connected the above electrical components through the circuit board 50. Power is thus supplied to the microprocessor, the thermistor and the LEDs.

After extensive research, it has been found that at certain core temperatures of livestock indicate the early onset of infection or even disease. Additionally, the onset of the livestock's estrus cycle is also predictable by measuring the core temperature of the animal. In cattle, it has been found that once a cow reaches 103.6° F. degrees, she is beginning her cycle and breeding should begin. Quite clearly this gives the manager a great advantage in knowing managing his resources to produce optimum yields.

By placing the thermistor 27 an extended distance into the cow's ear, core temperature can readily be measured. Thus, without having to manually insert a thermometer or other temperature measuring devices into the cow or other livestock, the core temperature is accurately measured.

It will be appreciated that within the spirit and scope of the invention herein, the thermistor 27 is preset for the desired temperature. Typically, and for safety and liability reasons this is done at the factory. However, upon ordering the device in accordance with the invention, the manager and can select a wide range of temperatures and serve the livestock's needs for a wide-ranging number of different breeds or conditions to be monitored.

While the foregoing detailed description has described several embodiments of the livestock temperature detection and monitoring device in accordance with this invention, it is to be understood that the above description is illustrative only and not limiting of the disclosed invention. It will be appreciated that two distinct embodiments of the invention have been described. The first exemplary embodiment monitors the livestock for illness or fever, and a threshold temperature is set as the threshold condition. The second exemplary embodiment monitors the livestock for breeding purposes. In the second embodiment, the microprocessor includes an algorithm, which monitors temperatures and compares the most recent temperature with early readings looking for a sudden, small but significant drop indicating the early onset of estrus. Other exemplary embodiments of the system in accordance with the invention are possible within the spirit and scope of the invention. Thus, the invention is to be limited only by the claims as set forth below.

What is claimed is:

1. A livestock temperature detection system, comprising:
a housing;
the housing including a probe;
the probe having a pre-set threshold temperature, the probe including:
a temperature sensing means for detecting an animal's temperature;
a display means, the display means visibly indicating when the pre-set threshold temperature has been reached; and
a monitoring means for monitoring when the threshold temperature is detected, the monitoring means including means for sending a signal to the display means for activating the display means when the threshold temperature has been reached,
whereby, upon reaching the threshold temperature, a visible display is activated and is observable by the livestock manager.

2. A livestock temperature detection system, comprising:
a housing;
the housing including a probe;
the probe having a pre-set threshold temperature, the probe including:
a temperature sensing means defining a thermistor for detecting an animal's temperature;
a display means, the display means visibly indicating when the pre-set threshold temperature has been reached; and
a monitoring means defining a microprocessor, which is electrically connected to the thermistor and the display means, the microprocessor monitors when the threshold temperature is detected, the microprocessor including means for electrically sending an electrical signal to the display means for activating the display means when the threshold temperature has been reached,
whereby, upon reaching the threshold temperature, a visible display is activated and is observable by the livestock manager.

3. The system as set forth in claim 1, wherein the monitoring means defines a micro-processor which sends an electrical signal to the display means upon sensing when the pre-set threshold temperature has been reached and for activating the display means.

4. The system as set forth in claim 2, wherein the thermistor is inserted into the livestock's ear for measuring the livestock's core temperature.

5. The system as set forth in claim 4, wherein the housing is made from a engineering plastic.

6. The system as set forth in claim 5, wherein the housing being made from UV polycarbonate.

7. The system as set forth in claim 2, wherein the housing is insulated from ambient temperatures.

8. The system as set forth in claim 6, wherein the weight of the housing is equal to or less than 1 ounce.

9. The system as set forth in claim 2, wherein the display means defines one or more LEDs.

10. The system as set forth in claim 2, wherein the display means defines one or more ultra-bright LEDs for visual observation.

11. A livestock temperature monitoring and detection system for providing an early indication of livestock breeding, comprising:
a housing;
the housing including a probe;
the probe including:
a temperature sensing means for detecting an animal's temperature;
a display means, the display means visibly indicating when the pre-set threshold condition has been reached; and
a microprocessor for monitoring the temperature sensing means and recording a series of data points from the animal's temperature, the microprocessor including an algorithm for comparing each of the data points for determining when the threshold condition has been detected, the monitoring means including means for sending a signal to the display means for activating the display means when the threshold condition has been reached; and
means for attaching the housing to the ear of the livestock.

12. The system as set forth in claim 11, wherein the means for attaching the housing defines a pliers.

13. The system as set forth in claim 12, wherein the housing has a base plate and the base plate includes one or more prongs and the housing includes a backing plate having compatible openings for the prongs, the prongs being made to pierce through the ear of livestock and lockably connect the prongs with the opening through the livestock's ear.

14. The system as set forth in claim 12, wherein the algorithm compares the newest data point with successive data points looking for a sudden drop in temperature, defining the threshold condition.
